(19) United States
(12) Patent Application Publication
(10) Pub. No.: US 2015/0079486 A1
(43) Pub. Date: Mar. 19, 2015

(54) FUEL CELL SYSTEM

(71) Applicant: Hyundai Motor Company, Seoul (KR)

(72) Inventors: Chang Ha LEE, Yongin-si (KR); Hyuck Roul KWON, Yongin-si (KR); Kyoung Ku HA, Anyang-si (KR)

(73) Assignee: HYUNDAI MOTOR COMPANY, Seoul (KR)

(21) Appl. No.: 14/102,330

(22) Filed: Dec. 10, 2013

(30) Foreign Application Priority Data
Sep. 13, 2013 (KR) 10-2013-0110153

(51) Int. Cl. H01M 8/04

(52) U.S. Cl. CPC H01M 8/04089
USPC 429/410

(57) ABSTRACT

A fuel cell system includes an enclosure having a fuel cell stack producing electricity via an electrochemical reaction between high temperature and high pressure compressed air generated by an air compressor and hydrogen used as fuel. A portion of the compressed air from the air compressor is introduced into the enclosure through a first pipe, and the compressed air flows towards the air compressor from the enclosure through a second pipe. The compressed air introduced into the enclosure via the first pipe removes moisture and hydrogen leaking out of the fuel cell stack and returns to the air compressor via the second pipe.

### CROSS-REFERENCE TO RELATED APPLICATION

The present application claims the benefit of priority to Korean Patent Application No. 10-2013-0110153 filed on Sep. 13, 2013, the entire contents of which is incorporated herein for all purposes by this reference.

### TECHNICAL FIELD

The present disclosure relates to a fuel cell system which can remove moisture and hydrogen which leak out of a fuel cell stack when producing electricity via a fuel cell, thereby preventing damage to internal parts of the fuel cell and improving operation stability of the fuel cell.

### BACKGROUND

Generally, a fuel cell stack for a fuel cell system triggers an electrochemical reaction between hydrogen used as fuel and oxygen in the air to produce electrical energy to drive a vehicle.

As shown in FIG. 1, a fuel cell vehicle includes a fuel cell stack 2 which produces electricity, a humidifier 4 which humidifies fuel and air and supplies the humidified mixture to the fuel cell stack 2, a fuel feeder which feeds hydrogen to the humidifier 4, and an oxygen feeder which feeds oxygen to the humidifier 4.

The air feeder includes a filter 6 which removes foreign substances contained in the external air and an air compressor 8 which compresses air to supply to the humidifier 4.

The fuel cell system includes a fuel processing system (FPS) 10 to control the pressure of hydrogen, which is supplied from the fuel feeder, i.e. a hydrogen tank, to the fuel cell stack, and the like.

According to the above-mentioned configuration, electricity is produced through an electrochemical reaction between hydrogen supplied from the fuel feeder, and oxygen supplied from the air feeder, while water and heat are additionally generated.

Heat is cooled by cooling water, and the generated water is discharged to the outside via an air-vent line. Here, some of hydrogen or moisture leak out of the fuel cell stack and are collected in an enclosure 12 of the fuel cell system. That is, although the fuel cell stack is configured in a gas-hermetic seal structure such that gas cannot leak inside and outside of the fuel cell stack, there is a sealing problem due to the design structure, causing some of the moisture and hydrogen to leak to the outside.

Such leak of hydrogen and moisture may cause problems in operational stability of the fuel cell system and corrosion of internal parts of the fuel cell stack and the enclosure of the fuel cell system, respectively.

In order to solve these problems, conventional methods in which, as shown in FIG. 1, a fan 14 is installed to the enclosure 12 so as to discharge the leaked hydrogen or water vapor to the outside, or otherwise, air in the enclosure is sucked to the outside using negative pressure formed by a suction filter. However, such methods have a poor sealing performance because the inside and outside of the enclosure are connected by a passage through which irregular discharge of leaks occurs.

The foregoing is intended merely to aid in the understanding of the background of the present disclosure, and is not intended to mean that the present disclosure falls within the purview of the related art that is already known to those skilled in the art.

### SUMMARY

The present disclosure has been made keeping in mind the above problems occurring in the related art and proposes a fuel cell system to remove moisture and hydrogen which leak out of a fuel cell stack during the production of electricity via a fuel cell, thereby preventing damage to internal parts of the fuel cell and improving operational stability of the fuel cell.

According to an embodiment of the present disclosure, a fuel cell system includes an enclosure having a fuel cell stack producing electricity via an electrochemical reaction between high temperature and high pressure compressed air generated by an air compressor and hydrogen used as fuel. A portion of the compressed air generated from the air compressor is introduced into the enclosure through a first pipe, and the compressed air flows towards the air compressor from the enclosure through a second pipe. The compressed air, which is introduced into the enclosure via the first pipe, removes moisture and hydrogen leaking out of the fuel cell stack and returns to the air compressor via the second pipe.

The enclosure may have an inlet and an outlet on opposite sides thereof, to which the first pipe and the second pipe are connected, respectively, and the inlet and the outlet are hermetically sealed with respect to an inside of the enclosure.

The first and second pipes may be connected to the enclosure and disposed opposite each other on the fuel cell stack.

The first pipe may be connected between an outlet flow line of the air compressor and the enclosure, and the second pipe may be connected between the enclosure and an inlet flow line of the air compressor.

The air compressor may have a power motor for rotating an impeller, and an air flow passage such that the compressed air generated by the rotation of the impeller partially passes through an inside of the motor so as to cool the motor.

The first pipe may be connected between an air outlet of the motor and the enclosure, and the second pipe may be connected between the enclosure and an inlet of the air compressor.

An outlet of the air compressor may have a bypass through which a portion of the compressed air is bypassed, the first pipe may be connected between the outlet of the air compressor and the enclosure so that the compressed air bypassed from the air compressor is introduced into the enclosure, and the second pipe may be connected between the enclosure and an inlet of the air compressor so that the air passing through the enclosure flows back to the air compressor.

According to the present disclosure, the fuel cell system having the above-mentioned configuration removes the moisture and hydrogen which leak out of the fuel cell stack when producing electricity, thereby preventing damage to internal parts of the fuel cell stack and improving operational stability of the fuel cell.

Warm air, which is heated during cooling the motor of the air compressor, is supplied to the inside of the enclosure, thereby improving a moisture-removal efficiency in the enclosure.

Furthermore, the compressed air generated by the air compressor is bypassed and supplied to the inside of the enclosure, thereby improving cooling efficiency of the fuel cell stack, and securing a surge margin to improve the operational performance of the air compressor at the same time.

### BRIEF DESCRIPTION OF THE DRAWINGS

The above and other objects, features and advantages of the present disclosure will be more clearly understood from the following detailed description when taken in conjunction with the accompanying drawings.

FIG. 1 is a view showing a conventional fuel cell system.

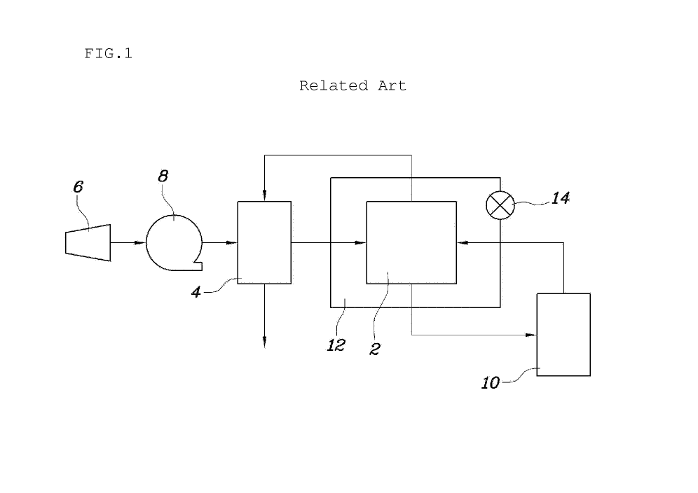

FIG. 2 is a view showing a configuration of a fuel cell system according to a first embodiment of the present disclosure.

FIG. 3 is a view showing a configuration of a fuel cell system according to a second embodiment of the present disclosure.

FIG. 4 is a view showing a configuration of a fuel cell system according to a third embodiment of the present disclosure.

### DETAILED DESCRIPTION

Hereinbelow, a description is made in detail for a fuel cell system according to embodiments of the present disclosure with reference to the accompanying drawings.

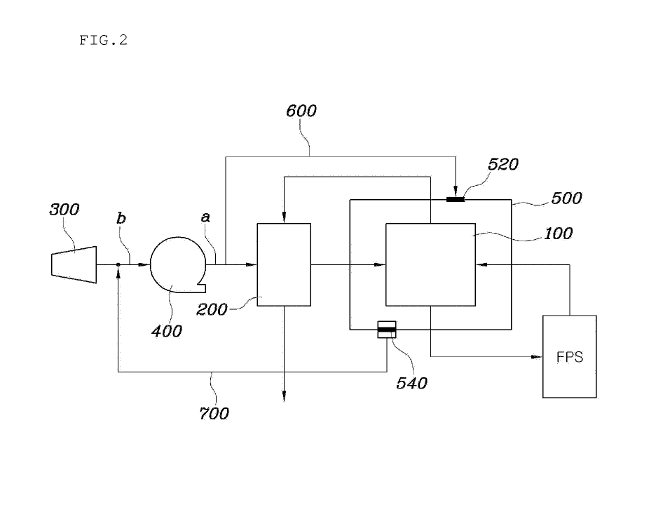

Referring to FIG. 2, a fuel cell system, which is adapted to fuel cell vehicles, includes a fuel cell stack 100 which produces electricity, and a humidifier 200 which humidifies a fuel and air mixture and supplies the humidified mixture to the fuel cell stack 100. A fuel feeder feeds hydrogen to the humidifier 200, and an air feeder feeds air containing oxygen to the humidifier. The air feeder includes a filter 300 which removes foreign substances contained in the external air, and an air compressor 400 which supplies compressed air to the humidifier.

Such fuel cell systems have been already known in the art, so that a detailed description of respective elements thereof will be omitted. However, the present disclosure is not limited to the technical features of the constitutional elements of the fuel cell system.

The present disclosure provides a fuel cell system to efficiently remove hydrogen and water steam collected in an enclosure 500 in which a fuel cell stack 100 is provided and to secure a surge margin at the same time, while cooling a motor 440 of an air compressor 400.

The fuel cell system includes an enclosure 500 having a fuel cell stack 100 which produces electricity via an electrochemical reaction between high temperature and high pressure compressed air generated by an air compressor 400 and hydrogen used as fuel. A portion of the compressed air generated from the air compressor 400 is introduced into the enclosure 500 through a first pipe 600, and the compressed air flows back to the air compressor 400 from the enclosure 500 through a second pipe 700. The compressed air introduced into the enclosure 500 via the first pipe 600 removes moisture and hydrogen leaking out of the fuel cell stack 100 and returns to the air compressor 400 via the second pipe 700.

That is, the moisture collected in the enclosure 500 evaporates due to the compressed air and is discharged from an inside of the enclosure 500 along with the compressed air flowing from the first pipe 600 to the second pipe 700. In this way, the air removes the moisture and hydrogen in the enclosure 500 and flows back to the air compressor 400 to repeat the circulation.

The enclosure 500 pressure-seals the fuel cell stack 100 in order to stably mount the fuel cell stack 100 and protect the same from external shock. Known technologies can be widely adapted to the enclosure, and the present disclosure is not limited thereto.

The enclosure 500 connects the first and second pipes 600 and 700. The first and second pipes 600 and 700 allow the compressed air, which is generated by the air compressor 400, to pass through the enclosure 500 and flow back to the air compressor 400. That is, the compressed air removes moisture and hydrogen in the enclosure 500 and returns to the air compressor 400 so as to supplement air flow in the air compressor. The connection to the first and second pipes 600 and 700 will be described hereinafter.

The enclosure 500 may have an inlet 520 and an outlet 540 on opposite sides thereof, to which the first pipe 600 and the second pipe 700 are connected, respectively, wherein the inlet 520 and the outlet 540 are hermetically sealed with respect to the inside of the enclosure 500.

Conventionally, hydrogen and water steam in the enclosure 500 are removed using a cooling fan or negative pressure. However, according to such conventional method, gas is permeable through the enclosure, degrading the hermetic-sealing capability.

On the contrary, according to the present disclosure, hydrogen and moisture in the enclosure 500 are removed using high temperature and high pressure compressed air, which is generated by the air compressor 400. To this end, the enclosure 500 has the inlet 520 and the outlet 540 to which the first and second pipes 600 and 700 are connected, respectively, so that the compressed air from the air compressor 400 flows in and out of the enclosure 500 through the respective pipes.

The inlet 520 and the outlet 540 of the enclosure 500 are hermetically sealed so as to improve the sealing capability. The internal space of the enclosure 500 is completely sealed, so that the compressed air introduced through the inlet 520 is completely discharged from the enclosure 500 through the outlet 540. Thus, smooth circulation of the compressed air is ensured, and loss of the compressed air is prevented.

The first and second pipes 600 and 700 may be connected to the enclosure 500 in such a way as to be opposite each other on the fuel cell stack 100.

As described before, the enclosure 500 is connected between the first and second pipes 600 and 700 such that the compressed air introduced through the first pipe 600 is sufficiently circulated in the enclosure 500 and then discharged from the enclosure 500 through the second pipe 700, while removing the hydrogen and moisture in the enclosure.

If the first and second pipes 600 and 700 are too close to each other, in other words adjacent each other, when connected to the enclosure 500, the compressed air introduced through the first pipe 600 cannot be sufficiently circulated in the enclosure 500 and is discharged from the enclosure 500 through the second pipe 700, so the hydrogen and moisture in the enclosure may not be sufficiently removed. Thus, the first and second pipes 600 and 700 may be installed farther away from each other.

That is, the first and second pipes 600 and 700 are connected to the enclosure 500 opposite each other on the fuel cell stack 100, so that the compressed air introduced through the first pipe 600 can be sufficiently circulated in the enclosure 500 and discharged therefrom through the second pipe 700.

Other embodiments of the present disclosure will now be described.

As shown in FIG. 2, the first pipe 600 may be connected between an outlet flow line a of the air compressor 400 and the enclosure 500, and the second pipe 700 may be connected between the enclosure 500 and an inlet flow line b of the air compressor 400.

Here, the flow line means a passage through which oxygen flows to the fuel cell stack 100 through the filter 300, the air compressor 400, and the humidifier 200 as shown in FIG. 2.

The first embodiment of the present disclosure described above provides a basic conceptual structure of the fuel cell system in which the first pipe 600 is connected between the outlet flow line a of the air compressor 400 and the enclosure 500 so that the compressed air generated by the air compressor 400 partially flows to the first pipe 600 when flowing towards the humidifier 200. According to an embodiment of the present disclosure, the first pipe 600 is connected to the flow line a through which the compressed air flows, and a portion of the compressed air can be introduced into the enclosure 500 so as to remove the moisture leaking out of the fuel cell stack 100.

When the second pipe 700 is connected between the enclosure 500 and the inlet flow line b of the air compressor according to an embodiment of the present disclosure, the compressed air can be discharged from the enclosure 500 through the second pipe 700 after removing the moisture. Here, the compressed air discharged through the second pipe 700 can be discharged together with hydrogen contained in the enclosure 500. That is, the moisture and hydrogen in the enclosure 500 can be removed at the same time.

With the configuration in which the compressed air discharged through the second pipe 700 flows through the inlet flow line b of the air compressor 400 so that the air passing through the inside of the enclosure 500 flows back to the air compressor 400, the compressed air can be preserved.

Further, the air compressor 400 may have a power motor 440 to rotate an impeller 420 and an air flow passage 460 to partially pass the compressed air generated with the rotation of the impeller 420 through the inside of the motor 440 so as to cool the motor 440.

Generally, an air compressor 400 used in a fuel cell vehicle rotates an impeller 420 with activation of a motor 440 so as to generate compressed air. The air compressor 400 of the present disclosure has the air flow passage 460 for the compressed air generated with the rotation of the impeller 420 such that the compressed air passes through the inside of the motor 440 to cool the motor 440.

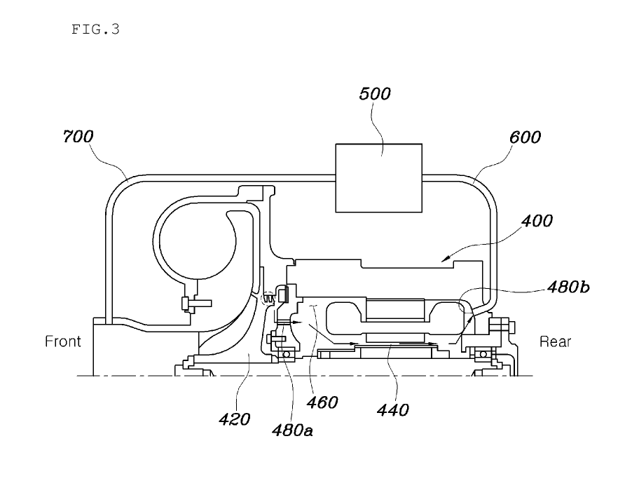

As shown in FIG. 3, air moves through the air flow passage 460, which is introduced into the casing of the impeller 420 via an inlet through-hole 480a at a rear side of the impeller 420 towards the motor 440, thereby cooling the motor 440. After cooling the motor 440, the air is discharged through an outlet through-hole 480b.

According to a second embodiment of the present disclosure, the first pipe 600 may be connected between an air outlet (or the outlet through-hole 480b) of the motor 440 and the enclosure 500, and the second pipe 700 may be connected between the enclosure 500 and an inlet of the air compressor 400.

Here, the compressed air, which is generated with the rotation of the impeller 420, partially passes through the motor 440 and cools the motor 440, and the compressed air is heated during this process. The heated compressed air is supplied to the enclosure 500 through the first pipe 600, thereby removing moisture collected in the enclosure 500.

Therefore, the air that has cooled the motor 440 of the air compressor 400 completely removes the moisture in the enclosure 500 after passing through the first pipe 600, and then is discharged out of the enclosure 500 through the second pipe 700 together with water steam and hydrogen.

Here, the second pipe 700 is connected to the inlet of the air compressor 400 at the enclosure 500, so that the air discharged through the second pipe 700 flows back to the air compressor 400 for reuse in the fuel cell stack 100, or otherwise former processes are repeated.

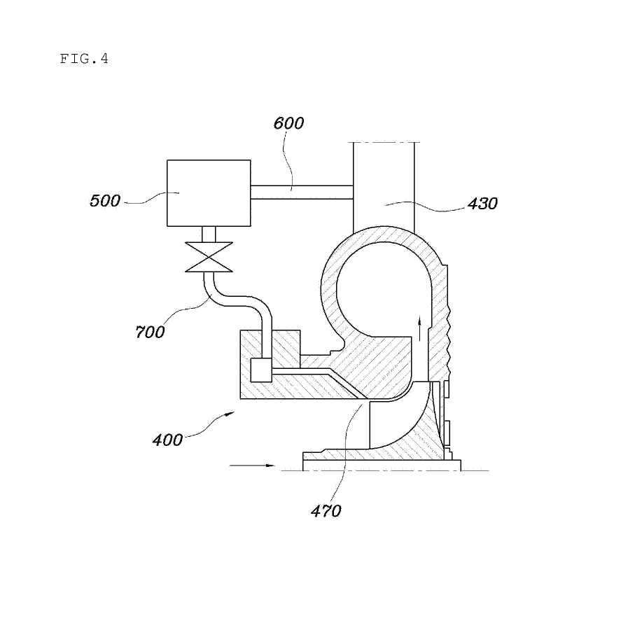

According to a third embodiment of the present disclosure, as shown in FIG. 4, an outlet 430 of the air compressor 400 may have a bypass through which a portion of the compressed air is bypassed. The first pipe 600 may be connected between the outlet 430 of the air compressor 400 and the enclosure 500 so that the compressed air bypassed from the air compressor 400 is introduced into the enclosure 500. The second pipe 700 may be connected between the enclosure 500 and an inlet 470 of the air compressor 400 so that the air passing through the enclosure 500 flows back to the air compressor 400. Here, the outlet 430 of the air compressor 400 is a flow passage through which the compressed air flows towards the fuel cell stack 100, and the inlet 470 is a passage through which the air is introduced towards the impeller 420 for compression.

The compressed air, which is generated by the air compressor 400, is not entirely supplied to the fuel cell stack 100 according to another embodiment of the present disclosure, a portion of the compressed air is bypassed at the outlet 430 of the air compressor 400, and the compressed air bypassed through the first pipe 600 is supplied into the enclosure 500, thus improving cooling performance of the fuel cell stack 100 and securing surge margin of the air compressor.

That is, according to the conventional technology, the compressed air is discharged to the outside because the conventional air compressor experiences a surge phenomenon at a low flow rate. However, according to the present disclosure, the compressed air is supplied from the air compressor 400 to the enclosure 500 through the first pipe 600, so that loss of flow rate is reduced. The surge margin is secured, and simultaneously, the fuel cell stack, which needs to maintain a temperature, is cooled, thus improving cooling efficiency thereof.

In this way, the air introduced into the enclosure 500 through the first pipe 600 flows back to the inlet 470 of the air compressor 400 through the second pipe 700, so that air flow rate can be maintained, the hydrogen and moisture in the enclosure 500 can be removed, the surge margin can also be secured, and the cooling efficiency of the stack can be improved.

The above-mentioned first to third embodiments can be selectively applied or as combination depending upon the design and specification of a vehicle.

The fuel cell system according to the present disclosure removes moisture and hydrogen which leak out of the fuel cell stack when producing electricity from the fuel cell stack 100, thereby preventing damage to internal parts of the fuel cell stack and improving operational stability of the fuel cell. Further, warm air, which is heated during cooling the motor 440 of the air compressor 400, is supplied to the inside of the enclosure 500, thereby improving moisture-removal efficiency in the enclosure 500.

In addition, the compressed air generated by the air compressor 400 is bypassed and supplied to the inside of the enclosure 500, thereby improving the cooling efficiency of the fuel cell stack 100, and at the same time, securing the surge margin to improve the operational performance of the air compressor 400.

Although an embodiment of the present disclosure has been described for illustrative purposes, those skilled in the art will appreciate that various modifications, additions, and substitutions are possible, without departing from the scope and spirit of the disclosure as disclosed in the accompanying claims.

What is claimed is:

1. A fuel cell system comprising:
an enclosure having a fuel cell stack producing electricity via an electrochemical reaction between high temperature and high pressure compressed air generated by an air compressor and hydrogen used as fuel;
a first pipe through which a portion of the compressed air generated from the air compressor is introduced into the enclosure; and
a second pipe through which the compressed air flows towards the air compressor from the enclosure,
wherein the compressed air introduced into the enclosure via the first pipe removes moisture and hydrogen leaking out of the fuel cell stack and returns to the air compressor via the second pipe.

2. The fuel cell system according to claim 1, wherein the enclosure has an inlet and an outlet on opposite sides thereof, to which the first pipe and the second pipe are connected, respectively, and the inlet and the outlet are hermetically sealed with respect to an inside of the enclosure.

3. The fuel cell system according to claim 1, wherein the first and second pipes are connected to the enclosure and disposed opposite each other on the fuel cell stack.

4. The fuel cell system according to claim 1, wherein the first pipe is connected between an outlet flow line of the air compressor and the enclosure, and the second pipe is connected between the enclosure and an inlet flow line of the air compressor.

5. The fuel cell system according to claim 1, wherein the air compressor has a power motor for rotating an impeller and an air flow passage such that the compressed air generated with the rotation of the impeller partially passes through an inside of the motor so as to cool the motor.

6. The fuel cell system according to claim 5, wherein the first pipe is connected between an air outlet of the motor and the enclosure, and the second pipe is connected between the enclosure and an inlet of the air compressor.

7. The fuel cell system according to claim 1, wherein an outlet of the air compressor has a bypass through which a portion of the compressed air is bypassed, the first pipe is connected between the outlet of the air compressor and the enclosure so that the compressed air bypassed from the air compressor is introduced into the enclosure, and the second pipe is connected between the enclosure and an inlet of the air compressor so that the air passing through the enclosure flows back to the air compressor.
